(19) United States
(12) Patent Application Publication
(10) Pub. No.: US 2004/0107322 A1
(43) Pub. Date: Jun. 3, 2004

(54) System and method for dynamically allocating shared memory within a multiple function device

(76) Inventor: Daniel Mulligan, Austin, TX (US)

Correspondence Address: GARLICK HARRISON & MARKISON LLP, P.O. BOX 160727, AUSTIN, TX, 78716-0727, US

(21) Appl. No.: 10/722,998

(22) Filed: Nov. 26, 2003

Related U.S. Application Data
(60) Provisional application No. 60/429,941, filed on Nov. 29, 2002.

(51) Int. Cl. G06F 12/00

(52) U.S. Cl. 711/147; 711/170

(57) ABSTRACT

An apparatus and method that provides dynamic buffer allocation of shared memory within a multiple function integrated circuit. This apparatus includes a processing module and shared memory coupled to the processing module. Shared memory stores operational instructions for the processing module based on the mode of operation. The multiple function integrated circuit identifies active modules operably coupled to the multiple function integrated circuit that require buffered memory. The circuit further determines the buffer requirements for the identified active module(s) and allocates shared memory into buffers for use by the active modules.

### RELATED APPLICATIONS

This application claims priority under 35 USC § 119(e) to U.S. Provisional Patent Application Ser. No. 60/429,941 filed Nov. 29, 2002 entitled, “MULTI-FUNCTION HANDHELD DEVICE”, and is incorporated herein by reference in its entirety.

### TECHNICAL FIELD OF THE INVENTION

The present invention relates generally to sharing of memory, and more particularly, a system and method for allocating shared memory within a multiple function device.

### BACKGROUND OF THE INVENTION

As is known, integrated circuits are used in a wide variety of electronic equipment, including portable, or handheld, devices. Such handheld devices include personal digital assistants (PDA), CD players, MP3 players, DVD players, AM/FM radio, a pager, cellular telephones, computer memory extension (commonly referred to as a thumb drive), etc. Each of these handheld devices includes one or more integrated circuits to provide the functionality of the device. For example, a thumb drive may include an integrated circuit for interfacing with a computer (e.g., personal computer, laptop, server, workstation, etc.) via one of the ports of the computer (e.g., Universal Serial Bus, parallel port, etc.) and at least one other memory integrated circuit (e.g., flash memory). As such, when the thumb drive is coupled to a computer, data can be read from and written to the memory of the thumb drive. Accordingly, a user may store personalized information (e.g., presentations, Internet access account information, etc.) on his/her thumb drive and use any computer to access the information.

As another example, an MP3 player may include multiple integrated circuits with multiple functional modules that support the storage and playback of digitally formatted audio (i.e., formatted in accordance with the MP3 specification). As is known, one integrated circuit may be used for interfacing with a computer, another integrated circuit for generating a power supply voltage, another for processing the storage and/or playback of the digitally formatted audio data, and still another for rendering the playback of the digitally formatted audio data audible. Additionally, each functional module may require dedicated memory in order to operate properly.

Integrated circuits have enabled the creation of a plethora of handheld devices, however, to be “wired” in today's electronic world, a person needs to posses multiple handheld devices. For example, one may own a cellular telephone for cellular telephone service, a PDA for scheduling, address book, etc., one or more thumb drives for extended memory functionality, an MP3 player for storage and/or playback of digitally recorded music, a radio, etc. Thus, even though a single handheld device may be relatively small, carrying multiple handheld devices on one's person can become quite burdensome.

Therefore, a need exists for integrated circuits that provide multiple functions for handheld devices, associated operations of the integrated circuits, and applications of the integrated circuits. To reduce the memory requirements of the integrated circuits, resources, such as memory dedicated to the exclusive use of a single functional module ought to be shared among many functional modules within the integrated circuit.

### SUMMARY OF THE INVENTION

The present invention provides an apparatus for dynamic buffer allocation of shared memory within a multiple function integrated circuit that substantially address these needs and others. This apparatus includes a processing module and shared memory coupled to the processing module. Shared memory stores operational instructions for the processing module based on the mode of operation. The multiple function integrated circuit identifies active modules operably coupled to the multiple function integrated circuit that require buffered memory. The circuit further determines the buffer requirements for the identified active module(s) and allocates shared memory into buffers for use by the active modules.

Another embodiment of the present invention provides a method for dynamic buffer allocation of shared memory within a multiple function integrated circuit. This process involves first determining the mode of operation of the multiple function integrated circuit. Active modules requiring buffered memory based on the previously determined mode of operation are then identified. Once the active modules are identified buffer requirements for the active modules are determined and shared memory is allocated for buffers to be used by the active modules.

### BRIEF DESCRIPTION OF THE DRAWINGS

FIG. 1 is a schematic block diagram of a handheld device and corresponding integrated circuit in accordance with the present invention;

FIG. 2 is a second schematic block diagram of a handheld device and a corresponding integrated circuit in accordance with the present invention;

FIG. 3 is a schematic block diagram of an embodiment of an integrated circuit in accordance with the present invention;

FIGS. 4A and 4B are diagrams depicting the allocation of shared memory in accordance with the present invention;

FIG. 5 is a logic diagram of a method that identifies and allocates memory in accordance with the present invention;

FIG. 6 is a logic diagram of a method that reallocates shared memory in accordance with the present invention; and

FIG. 7 is a logic diagram of a method that determines memory requirements from activation of a device through the device's changing modes of operation in accordance with the present invention.

### DETAILED DESCRIPTION OF THE INVENTION

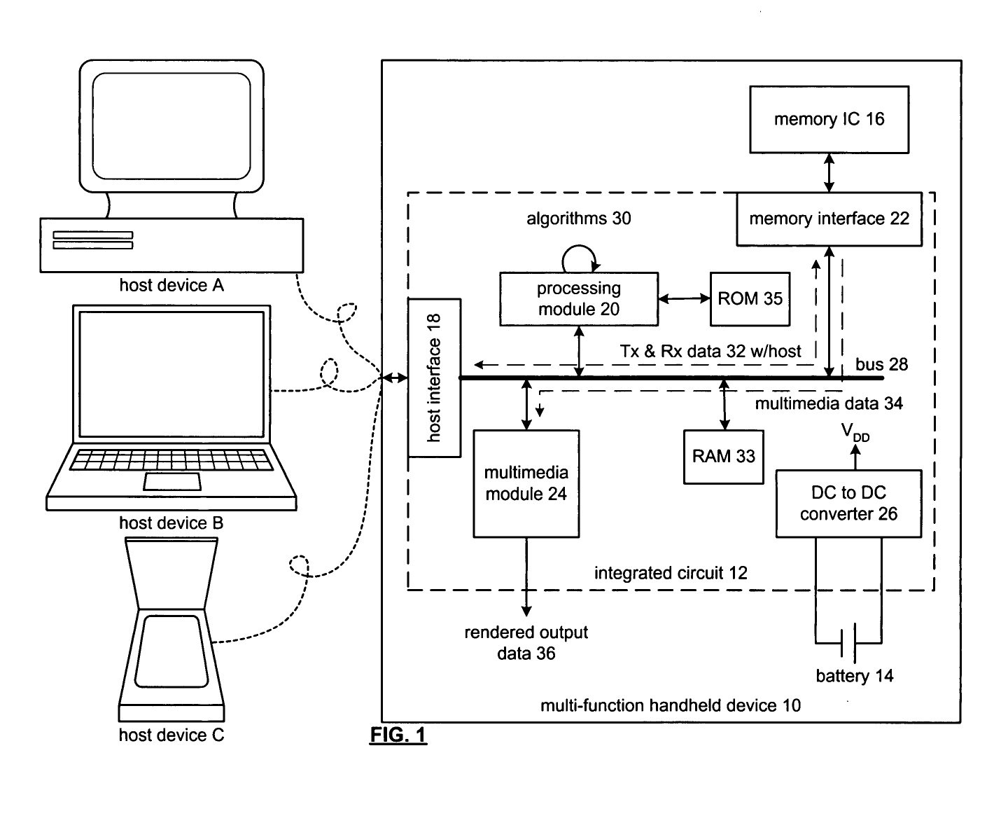

FIG. 1 is a schematic block diagram of a multi-function handheld device 10 and corresponding integrated circuit 12 operably coupled to a host device A, B, or C. The multi-function handheld device 10 also includes memory integrated circuit (IC) 16 and a battery 14. The integrated circuit 12 includes a host interface 18, a processing module 20, a memory interface 22, a multimedia module 24, a DC-to-DC converter 26, and a bus 28. The multimedia module 24 alone or in combination with the processing module 20 provides the functional circuitry for the integrated circuit 12. The DC-to-DC converter 26, which may be constructed in accordance with the teaching of U.S. Pat. No. 6,204,651, entitled METHOD AND APPARATUS FOR REGULATING A DC VOLTAGE, provides at least a first supply voltage to one or more of the host interface 18, the processing module 20, the multimedia module 24, and the memory interface 22. The DC-to-DC converter 26 may also provide V_{DD} to one or more of the other components of the handheld device 10.

When the multi-function handheld device 10 may operably couple to a host device A, B, or C, which may be a personal computer, workstation, server (which are represented by host device A), a laptop computer (host device B), a personal digital assistant (host device C), and/or any other device that may transceive data with the multi-function handheld device, the processing module 20 performs at least one algorithm 30. The corresponding operational instructions of the algorithm 30 are stored in memory 16 and/or in memory incorporated in or accessible to processing module 20. The processing module 20 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The associated memory may be a single memory device or a plurality of memory devices. Such a memory device may be a read-only memory, random access memory, volatile memory, non-volatile memory, static memory, dynamic memory, flash memory, and/or any device that stores digital information. Note that when the processing module 20 implements one or more of its functions via a state machine, analog circuitry, digital circuitry, and/or logic circuitry, the associated memory storing the corresponding operational instructions is embedded with the circuitry comprising the state machine, analog circuitry, digital circuitry, and/or logic circuitry.

With the multi-function handheld device 10 in the first functional mode, the integrated circuit 12 facilitates the transfer of data between the host device A, B, or C and memory 16, which may be non-volatile memory (e.g., flash memory, disk memory, SDRAM) and/or volatile memory (e.g., DRAM). In one embodiment, the memory IC 16 is a NAND flash memory that stores both data and the operational instructions of at least some of the algorithms 30. The interoperability of the shared memory 62, memory IC 16 and integrated circuit 12 will be described in greater detail.

In this mode, the processing module 30 retrieves a first set of operational instructions (e.g., a file system algorithm, which is known in the art) from the memory 16 to coordinate the transfer of data. For example, data received from the host device A, B, or C (e.g., Rx data) is first received via the host interface module 18. Depending on the type of coupling between the host device and the handheld device 10, the received data will be formatted in a particular manner. For example, if the handheld device 10 is coupled to the host device via a USB cable, the received data will be in accordance with the format proscribed by the USB specification. The host interface module 18 converts the format of the received data (e.g., USB format) into a desired format by removing overhead data that corresponds to the format of the received data and storing the remaining data as data words. The size of the data words generally corresponds directly to, or a multiple of, the bus width of bus 28 and the word line size (i.e., the size of data stored in a line of memory) of memory 16. Under the control of the processing module 20, the data words are provided, via the memory interface 22, to memory 16 for storage. In this mode, the handheld device 10 is functioning as extended memory of the host device (e.g., like a thumb drive).

In furtherance of the first functional mode, the host device may retrieve data (e.g., Tx data) from memory 16 as if the memory were part of the computer. Accordingly, the host device provides a read command to the handheld device, which is received via the host interface 18. The host interface 18 converts the read request into a generic format and provides the request to the processing module 20. The processing module 20 interprets the read request and coordinates the retrieval of the requested data from memory 16 via the memory interface 22. The retrieved data (e.g., Tx data) is provided to the host interface 18, which converts the format of the retrieved data from the generic format of the handheld device into the format of the coupling between the handheld device and the host device. The host interface 18 then provides the formatted data to the host device via the coupling.

The coupling between the host device and the handheld device may be a wireless connection or a wired connection. For instance, a wireless connection may be in accordance with Bluetooth, IEEE 802.11(a), (b) or (g), and/or any other wireless LAN (local area network) protocol, IrDA, etc. The wired connection may be in accordance with one or more Ethernet protocols, Firewire, USB, etc. Depending on the particular type of connection, the host interface module 18 includes a corresponding encoder and decoder. For example, when the handheld device 10 is coupled to the host device via a USB cable, the host interface module 18 includes a USB encoder and a USB decoder.

As one of average skill in the art will appreciate, the data stored in memory 16, which may have 64 Mbytes or greater of storage capacity, may be text files, presentation files, user profile information for access to varies computer services (e.g., Internet access, email, etc.), digital audio files (e.g., MP3 files, WMA—Windows Media Architecture—, MP3 PRO, Ogg Vorbis, AAC—Advanced Audio Coding), digital video files [e.g., still images or motion video such as MPEG (motion picture expert group) files, JPEG (joint photographic expert group) files, etc.], address book information, and/or any other type of information that may be stored in a digital format. As one of average skill in the art will further appreciate, when the handheld device 10 is coupled to the host device A, B, or C, the host device may power the handheld device 10 such that the battery is unused.

When the handheld device 10 is not coupled to the host device, the processing module 20 executes an algorithm 30 to detect the disconnection and to place the handheld device in a second operational mode. In the second operational mode, the processing module 20 retrieves, and subsequently executes, a second set of operational instructions from memory 16 to support the second operational mode. For example, the second operational mode may correspond to MP3 file playback, digital dictaphone recording, MPEG file playback, JPEG file playback, text messaging display, cellular telephone functionality, and/or AM/FM radio reception. Each of these functions is known in the art, thus no further discussion of the particular implementation of these functions will be provided except to further illustrate the concepts of the present invention.

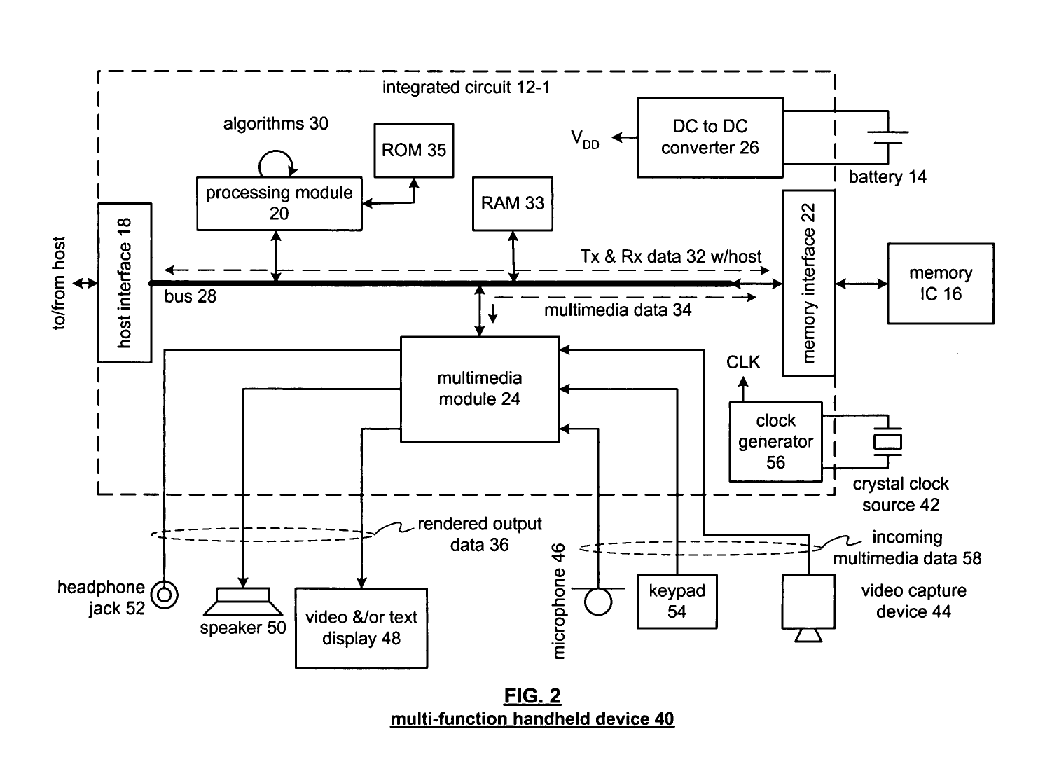

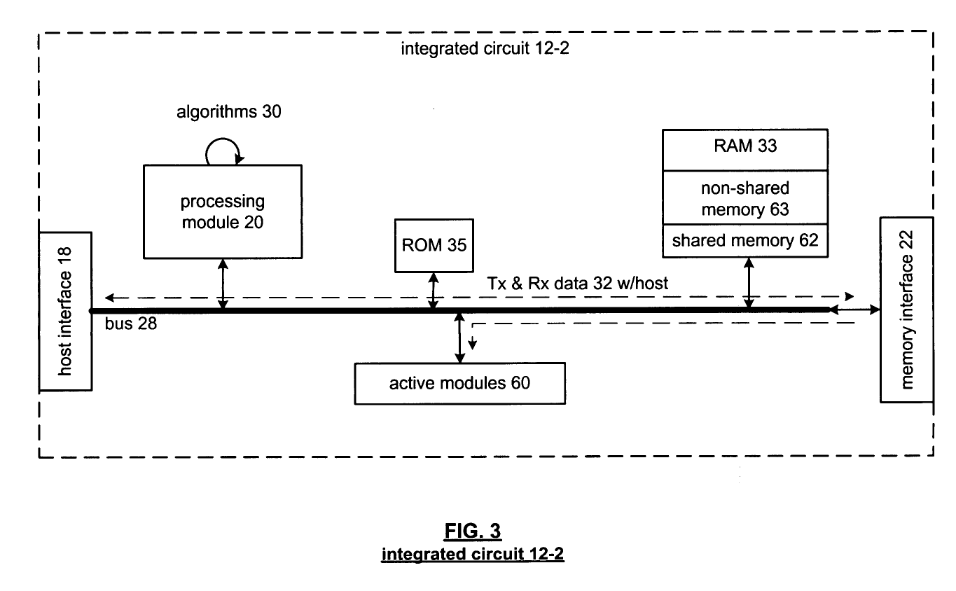

In the second operational mode, under the control of the processing module 20 executing the second set of operational instructions, the multimedia module 24 retrieves multimedia data 34 from memory 16. The multimedia data 34 includes at least one of digitized audio data, digital video data, and text data. Upon retrieval of the multimedia data, the multimedia module 24 converts the data 34 into rendered output data 36. For example, the multimedia module 24 may convert digitized data into analog signals that are subsequently rendered audible via a speaker or via a headphone jack. In addition, or in the alternative, the multimedia module 24 may render digital video data and/or digital text data into RGB (red-green-blue), YUV, etc., data for display on an LCD (liquid crystal display) monitor, projection CRT, and/or on a plasma type display. The multimedia module 24 will be described in greater detail with reference to FIGS. 2 and 3.

As one of average skill in the art, the handheld device 10 may be packaged similarly to a thumb drive, a cellular telephone, pager (e.g., text messaging), a PDA, an MP3 player, a radio, and/or a digital dictaphone and offer the corresponding functions of multiple ones of the handheld devices (e.g., provide a combination of a thumb drive and MP3 player/recorder, a combination of a thumb drive, MP3 player/recorder, and a radio, a combination of a thumb drive, MP3 player/recorder, and a digital dictaphone, combination of a thumb drive, MP3 player/recorder, radio, digital dictaphone, and cellular telephone, etc.).

FIG. 2 is a schematic block diagram of another handheld device 40 and a corresponding integrated circuit 12-1. In this embodiment, the handheld device 40 includes the integrated circuit 12-1, the battery 14, the memory 16, a crystal clock source 42, one or more multimedia input devices (e.g., one or more video capture device(s) 44, keypad(s) 54, microphone(s) 46, etc.), and one or more multimedia output devices (e.g., one or more video and/or text display(s) 48, speaker(s) 50, headphone jack(s) 52, etc.). The integrated circuit 12-1 includes the host interface 18, the processing module 20, the memory interface 22, the multimedia module 24, the DC-to-DC converter 26, and a clock generator 56, which produces a clock signal (CLK) for use by the other modules. As one of average skill in the art will appreciate, the clock signal CLK may include multiple synchronized clock signals at varying rates for the various operations of the multi-function handheld device.

Handheld device 40 functions in a similar manner as handheld device 10 when exchanging data with the host device (i.e., when the handheld device is in the first operational mode). In addition, while in the first operational mode, the handheld device 40 may store digital information received via one of the multimedia input devices 44, 46, and 54. For example, a voice recording received via the microphone 46 may be provided as multimedia input data 58, digitized via the multimedia module 24 and digitally stored in memory 16. Similarly, video recordings may be captured via the video capture device 44 (e.g., a digital camera, a camcorder, VCR output, DVD output, etc.) and processed by the multimedia module 24 for storage as digital video data in memory 16. Further, the key pad 54 (which may be a keyboard, touch screen interface, or other mechanism for inputting text information) provides text data to the multimedia module 24 for storage as digital text data in memory 16. In this extension of the first operational mode, the processing module 20 arbitrates write access to the memory 16 among the various input sources (e.g., the host and the multimedia module).

When the handheld device 40 is in the second operational mode (i.e., not connected to the host), the handheld device may record and/or playback multimedia data stored in the memory 16. Note that the data provided by the host when the handheld device 40 was in the first operational mode includes the multimedia data. The playback of the multimedia data is similar to the playback described with reference to the handheld device 10 of FIG. 1. In this embodiment, depending on the type of multimedia data 34, the rendered output data 36 may be provided to one or more of the multimedia output devices. For example, rendered audio data may be provided to the headphone jack 52 and/or to the speaker 50, while rendered video and/or text data may be provided to the display 48.

The handheld device 40 may also record multimedia data 34 while in the second operational mode. For example, the handheld device 40 may store digital information received via one of the multimedia input devices 44, 46, and 54.

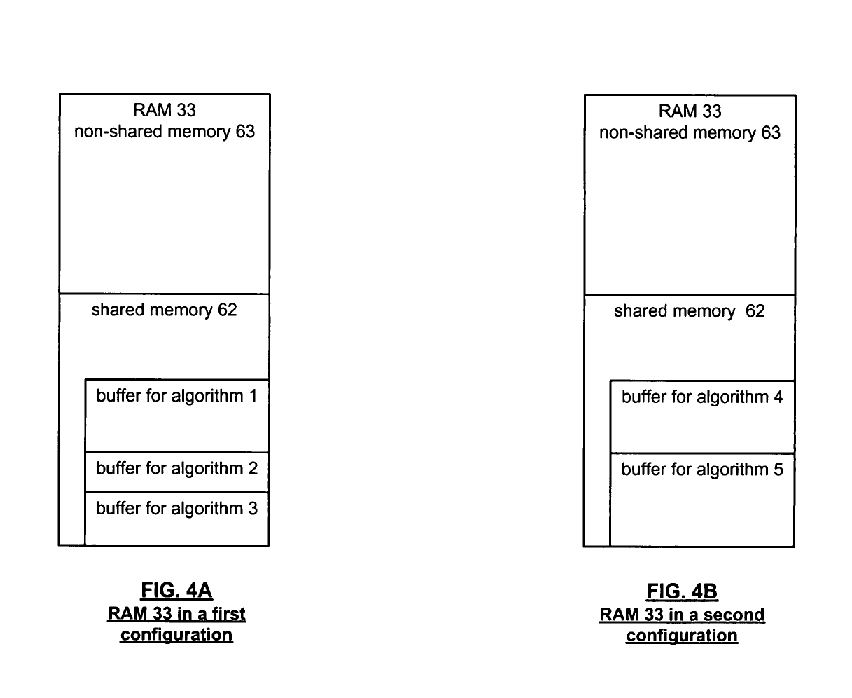

FIG. 3 is a schematic block diagram of integrated circuit 12 wherein RAM 33 is divided between shared memory 62 and non-shared memory 63. As previously stated, integrated circuit 12 includes a processing module 20 operable to execute algorithms 30, ROM 35, RAM 33, host interface 18, bus 28, a memory interface 22, and a number of active modules 60. Processing module 20 is operable to execute algorithms 30, which determine the mode of operation of integrated circuit 12. Processing module 20 based on the mode of operation identified by algorithms 30 is able to detect and identify active module 60 coupled to processing module 20 via bus 28. When the active modules 60 are identified, the processing module determines the amount of buffer space required from shared memory 62 located within RAM 33 for each active module 60. The allocation of this memory will further be described in the examples provided in FIGS. 4A and 4B. Once processing module 20 determines the buffer requirements for the identified active module 60, processing module 20 allocates memory space within the shared memory 62.

FIG. 4A illustrates one configuration of shared memory and non-shared memory based on a first mode of operation. Here RAM 33 is divided into a non-shared memory 63 and shared memory 62. As shown, algorithm 1, algorithm 2, and algorithm 3 have buffer space allocated to each within the shared memory 62. Processing module 20 identifies only active modules 60 to be utilized in the current mode of operation.

A number of active modules 60 may couple to bus 28 such as universal serial bus (USB) devices, flash memory devices, electronically programmable read-only memory (EPROM)devices, multi-wired devices, hard-drive devices, digital-to-analog converters (DAC), analog-to-digital (ADC), or other like devices known to those skilled in the art. Each of these devices may require memory (or buffer) in order to efficiently communicate and operate with integrated circuit 12. By identifying only those active modules to be utilized during a specific mode of operation, one may assign shared memory in the form of buffers to only those active modules currently in use that require shared memory. This ensures that for a given mode of operation, the shared memory can be allocated to maximize the operations of the integrated circuit 12. Memory that would otherwise be dedicated to inactive modules may now be used by other functions within integrated circuit 12.

FIG. 4B illustrates a second configuration or RAM 33. Here, shared memory 62 is allocated to algorithms 4 and 5. No memory in this instance is allocated to algorithm 1, algorithm 2, or algorithm 3 as previously configured in FIG. 4A. Algorithm 4 and algorithm 5 may relate to different devices or active modules other than those utilized in the configuration described in FIG. 4A or the same modules with different memory requirements given the different mode of operation. This illustrates how the total memory requirement is reduced as the memory that would of previously been assigned to algorithm 4 and algorithm 5 in the first configuration need not be utilized for the modules associated with algorithm 4 and algorithm 5 in the memory configuration of FIG. 4A.

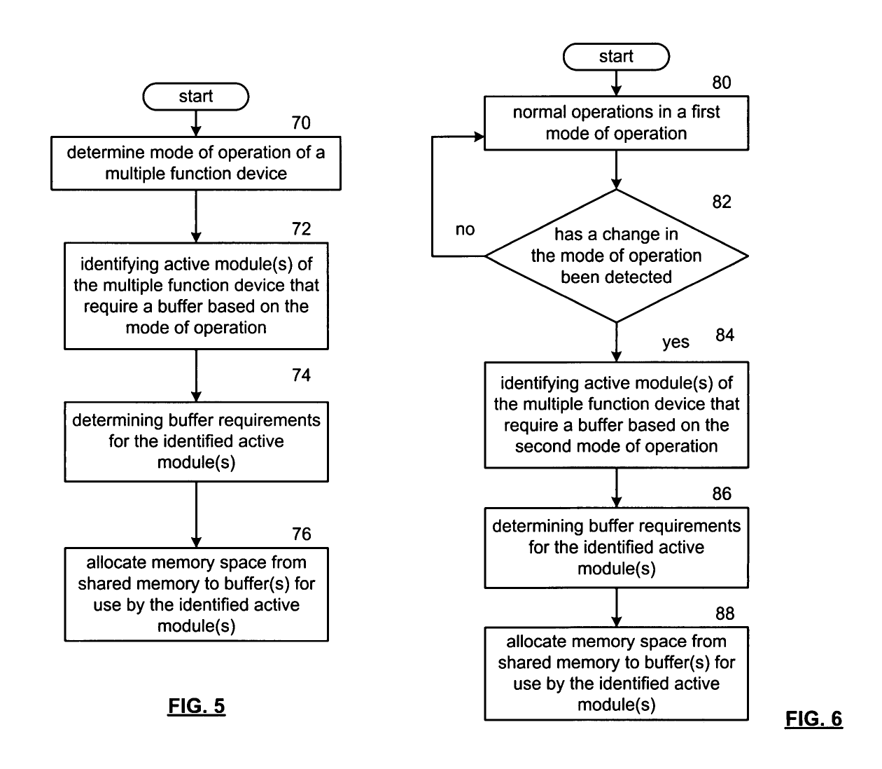

FIG. 5 is a logic flow diagram illustrating the processes associated with the present invention. Beginning at Step 70, the mode of operation of a multiple function device is determined. The active modules associated with the multiple function device that require buffer or memory based on the determined mode of operation are identified in Step 72. The buffer requirements associated with the identified active modules at Step 72 are determined in Step 74. Memory space from shared memory is then allocated to individual buffers for particular active modules in Step 76.

Memory may be allocated when the device is started-up, when the mode of operation of the device changes, or continuously and dynamically throughout device operation or operations of the multiple function integrated circuit. FIG. 6 is a logic flow diagram illustrating the steps of altering the allocation of memory within shared memory. The process starts at Step 80 wherein the multiple function integrated circuit or multiple function device is conducting normal operations in a first mode of operation. The device continuously monitors for a change in the mode of operation. This may be signaled by repositioning a hardware switch, docking or undocking the device to another device or host, or manipulating a software switch. At decision point 82, the multiple function integrated circuit 12 determines whether or not such a change in the mode of operation has occurred. If no change has been detected, normal operations continue as described in Step 80. However, if a change in the mode of operation has been detected, the active modules associated with the second mode of operation of the multiple function device are identified in Step 84. In Step 86, the buffer requirements of the identified active modules from Step 84 are determined following which memory space from shared memory is reallocated to buffers for use by the newly identified active modules. This allows the multiple function device to more efficiently operate in various modes of operation.

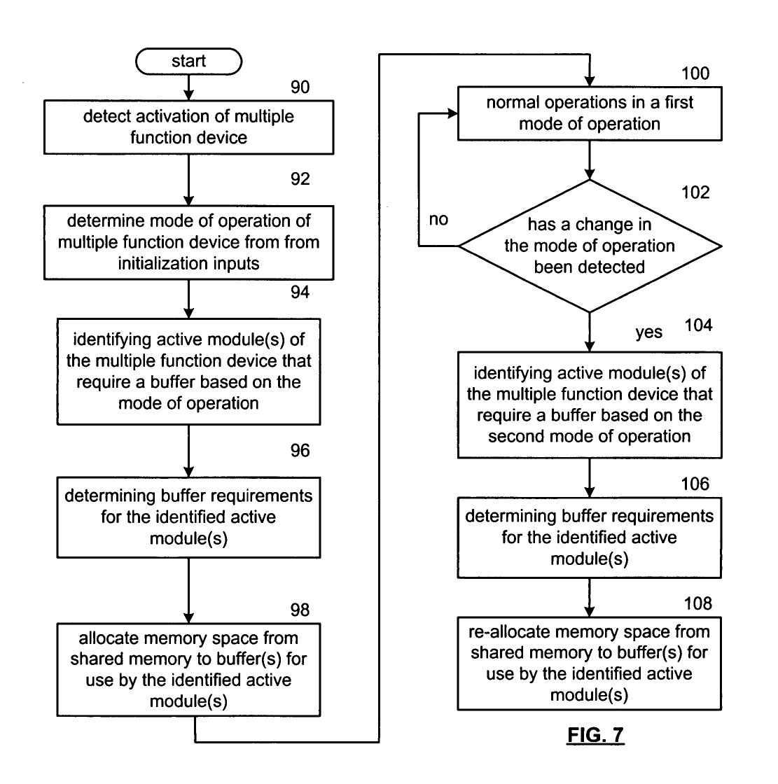

FIG. 7 provides an overall process flow from device activation for changes in the mode of operation of the device with respect to allocating shared memory. At Step 90, the activation of the multiple function device is detected. On detection the 1^{st} mode of operation of the multiple function device is determined from initialization inputs. These may be boot inputs within the integrated circuit. Alternatively, these inputs may be associated with operably coupling the multiple function integrated circuit 12 to a host through host interface 18. In this case, the host operably couples to integrated circuit 12 determines the mode of operation of the integrated circuit 12. At Step 94, active modules associated with the determined mode of operation are identified. Next, the buffer requirements for those active modules are determined in Step 96. Step 98 allocates memory space within shared memory for use by the identified active modules. This allows normal operations in a first mode of operation to progress at Step 100. The device will then continuously monitor for a change in the mode of operation at decision point 102. This may involve a manual switch, the coupling or decoupling of the integrated circuit to a new or different host, a software switch, or other like switch known to those skilled in the art. The active modules and their buffer requirements are identified and determined in Steps 104 and 106 based on the new mode of operation of the integrated circuit. This allows shared memory to be reallocated for use by the newly identified active modules in Step 108.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions and alterations can be made hereto without departing from the spirit and scope of the invention as described by the appended claims.

What is claimed is:

1. A method for dynamic buffer allocation of shared memory within a multiple function integrated circuit, the method comprises:
determining mode of operation of the multiple function integrated circuit;
identifying at least one active module of a plurality of modules of the multiple function integrated circuit requiring a buffer based on the mode of operation;
determining buffer requirements for the at least one active module; and
allocating memory space of the shared memory for the buffer to be used by the at least one active module.

2. The method of claim 1, wherein the at least one active module comprises at least two of:
a processing unit;
universal serial bus (USB) device;
digital to analog converter (DAC); and
analog to digital converter (ADC).

3. The method of claim 1, wherein the mode of operation comprises at least one mode of operation selected from the group comprising:
a digital audio player mode;
a file storage device mode;
a digital multimedia player mode;
an extended memory device mode;
a digital audio recorder mode;
a digital multimedia recorder mode; and
a personal data assistant.

4. The method of claim 1, further comprises:
changing the mode of operation of the multiple function integrated circuit to a second mode of operation;
identifying at least one other active module of the plurality of modules requiring another buffer based on the second mode of operation;
determining buffer requirements for the at least one other active module; and
allocating memory space of the shared memory for the another buffer to be used by the at least one active module.

5. The method of claim 1, wherein the at least one active module has digital memory access (DMA) to the shared memory.

6. The method of claim 5, wherein the shared memory comprises on-chip random access memory.

7. A method for dynamic buffer allocation of shared memory within a multiple function integrated circuit during initialization of the multiple function integrated circuit, the method comprises:
determining a first mode of operation of the multiple function integrated circuit;
identifying at least one active module of a plurality of modules of the multiple function integrated circuit requiring a buffer based on the first mode of operation;
determining buffer requirements for the at least one active module; and
allocating memory space of the shared memory for a buffer to be used by the at least one active module.

8. The method of claim 7 that further comprises:
detecting activation of the multiple function integrated circuit;

9. The method of claim 8 that further comprises:
detecting a change from the first mode of operation of the multiple function integrated circuit to a second mode of operation;
identifying at least one active module of the plurality of modules of the multiple function integrated circuit requiring a buffer based on the second mode of operation;
determining buffer requirements for the at least one active module; and
allocating memory space of the shared memory for a buffer to be used by the at least one active module.

10. The method of claim 8, wherein the at least one active module comprises:
a processing unit;
universal serial bus (USB) device;
digital to analog converter (DAC); and
analog to digital converter (ADC).

11. The method of claim 8, wherein the first mode of operation and second mode of operation comprise at least one mode of operation selected from:
a digital audio player mode;
a file storage device mode;
a digital multimedia player mode;
an extended memory device mode;
a digital audio recorder mode;
a digital multimedia recorder mode; and
a personal data assistant.

12. The method of claim 8, wherein the at least one active module has digital memory access (DMA) to the shared memory.

13. The method of claim 11, wherein the shared memory comprises on-chip random access memory.

14. An apparatus for dynamic buffer allocation of shared memory within a multiple function integrated circuit, the apparatus comprises:
processing module; and
memory operably coupled to the processing module, wherein at least portion of the memory functions as the shared memory and wherein the memory stores operational instructions that cause the processing module to:
detect activation of the multiple function integrated circuit;
determine a first mode of operation of the multiple function integrated circuit;
identify the at least one active modules of the multiple function integrated circuit requiring a buffer based on the first mode of operation;
determine buffer requirements for the at least one identified active module; and
allocate memory space within the RAM for a buffer to be used by the at least one active module.

15. The apparatus of claim 14 wherein the memory further stores operational instructions that cause the processing module to:
detect a change from the first mode of operation of the multiple function integrated circuit to a second mode of operation;
identify at least one active module of the plurality of modules of the multiple function integrated circuit requiring a buffer based on the second mode of operation;
determine buffer requirements for the at least one active module; and
allocate memory space of the shared memory for a buffer to be used by the at least one active module.

16. The multiple function integrated circuit of claim 13, wherein the at least one active module further comprises at least one of:
universal serial bus (USB) device;
a flash memory device;
an electronically programmable read only memory (EPROM) device;
a multi-wire device;
a hard drive device;
digital to analog converter (DAC); and
analog to digital converter (ADC).

17. The multiple function integrated circuit of claim 13, wherein the first mode of operation and second mode of operation comprise at least one mode of operation selected from:
a digital audio player mode;
a file storage device mode;
a digital multimedia player mode;
an extended memory device mode;
a digital audio recorder mode;
a digital multimedia recorder mode; and
a personal data assistant.

18. The multiple function integrated circuit of claim 13, wherein the at least one active module has digital memory access (DMA) to the shared memory.

19. The multiple function integrated circuit of claim 13, wherein the processing module determines the first mode of operation from initialization inputs to the multiple function integrated circuit, wherein the initialization inputs identify active modules operable coupled to the multiple function integrated circuit.

20. The multiple function integrated circuit of claim 18, wherein the active modules include at least one of:
universal serial bus (USB) device;
a flash memory device;
an electronically programmable read only memory (EPROM) device;
a multi-wire device;
a hard drive device;
digital to analog converter (DAC); and
analog to digital converter (ADC).
